(19) United States
(12) Patent Application Publication
(10) Pub. No.: US 2008/0216507 A1
(43) Pub. Date: Sep. 11, 2008

(54) Food Platter cooler

(76) Inventor: Kevin H. Tremblay, Champlain, NY (US)

Correspondence Address: JAMES RAY & ASSOCIATES, 2640 PITCAIRN ROAD, MONROEVILLE, PA, 15146, US

(21) Appl. No.: 12/070,867

(22) Filed: Feb. 21, 2008

Related U.S. Application Data
(60) Provisional application No. 60/891,083, filed on Feb. 22, 2007.

(51) Int. Cl. F25D 3/08; A47J 47/00

(52) U.S. Cl. 62/457.2; 62/457.6

(57) ABSTRACT

An apparatus for at least one of retaining pre-selected food products and serving such pre-selected food products as desired includes a bottom member formed from a predetermined material having a predetermined hardness which is at least sufficient to provided a stiffness to the bottom member to prevent bending thereof. A first cavity is formed in the bottom member having a predetermined depth. A cooling gel member is disposed within the first cavity. Such cooling gel member includes a second cavity formed therein having a second predetermined depth. A plate member is disposed within such second cavity.

### CROSS REFERENCE TO RELATED APPLICATION

This patent application is related to and claims priority from U.S. Provisional Patent Application Ser. No. 60/891,083 filed Feb. 22, 2007.

### FIELD OF THE INVENTION

The present invention relates, in general, to trays which are utilized as food platters and/or servers and, more particularly, this invention relates to a food platter having a means for keeping food being served thereon cool that is incorporated therein.

### BACKGROUND OF THE INVENTION

Prior to the conception and development of the present invention, as is generally well known in the prior art, platters having various food items thereon are used to serve guests being entertained.

One well known way of preserving vegetables, and fruits fresh in a container is to place ice cubes into a lower portion of the container and then place them over the ice cubes. However, in this way, the foods are kept cool and fresh only a short period of time because the ice cubes that are directly contacted by the foods will melt, especially in hot summer days and accumulate in the container. Therefore, it is difficult for the foods to be kept cool and fresh for an extended period of time.

One attempt to solve this problem known to applicant is taught in U.S. Pat. No. 7,007,813. Taught therein is a serving tray for keeping foods fresh, particularly to one capable of having ice cubes put into compartments of a rotary tray, having various food items, such as vegetables, fruits or the like, respectively placed in different receiving pans without being mixed up, and then having the receiving pans located on the compartments of the rotary tray, by which the food items will soon be spread with cool air coming from the ice cubes and penetrating through a plurality of perforated holes of the receiving pans, thus enabling the food items to be kept fresh in cool temperature in a longer period for being tasted more delicious, and maintained with their individual unique flavors in a sanitary condition.

Other prior art known to Applicant is taught in U.S. Pat. Nos. 7,299,652 titled “Self-Contained Gel Insulated Container”; 7,131,289 titled “Container”; 6,651,970 titled “Multi-Functional Cutting Board”; 6,378,325 titled “Salad Bowl With Cooling Function”; 5,701,757 titled “Portable Refrigerator Food Container” 5,035,122 titled “Portable Containers For Maintaining Food Stuffs In A Chilled Condition” and U.S. Patent Publication No. 2003/0230110 titled “Cool Tray”.

### SUMMARY OF THE INVENTION

The present invention provides an apparatus for at least one of retaining pre-selected food products therein and serving such pre-selected food products as desired. The apparatus comprising a bottom member having each of a first predetermined shape, a first predetermined size and a first predetermined thickness. Such bottom member formed from a first predetermined material having a predetermined hardness. The predetermined hardness is at least sufficient to provided a stiffness to the bottom member which will prevent bending thereof. There is a first cavity formed in the bottom member having each of a second predetermined shape, a second predetermined size and a first predetermined depth. A cooling gel member having each of a third predetermined shape, a third predetermined size and a second predetermined thickness is disposed within such first cavity. A second cavity is formed in the cooling gel member having each of a fourth predetermined shape, a fourth predetermined size and a second predetermined depth. Finally, there is a plate member having each of a fifth predetermined shape and a fifth predetermined size disposed within such second cavity.

### OBJECTS OF THE INVENTION

It is, therefore, one of the primary objects of the present invention to provide an apparatus for at least one of retaining pre-selected food products therein and serving such pre-selected food products as desired which will maintain such food products cool.

Another object of the present invention is to provide an apparatus for at least one of retaining pre-selected food products therein and serving such pre-selected food products as desired which can be produced in a wide variety of sizes, shapes and sizes.

Still another object of the present invention is to provide an apparatus for at least one of retaining pre-selected food products therein and serving such pre-selected food products as desired which will preserve the food products crispness for a longer period of time when removed from the refrigerator.

Yet another object of the present invention is to provide an apparatus for at least one of retaining pre-selected food products therein and serving such pre-selected food products as desired which can include a plate member having a predetermined number of compartments for retaining a variety of food products.

An additional object of the present invention is to provide an apparatus for at least one of retaining pre-selected food products therein and serving such pre-selected food products as desired which is relatively easy to manufacture.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is an exploded view of a presently preferred embodiment of the invention; and

FIG. 2 is a perspective view showing the outer lid member hingedly attached to the bottom member of the food platter cooler illustrated in FIG. 1.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

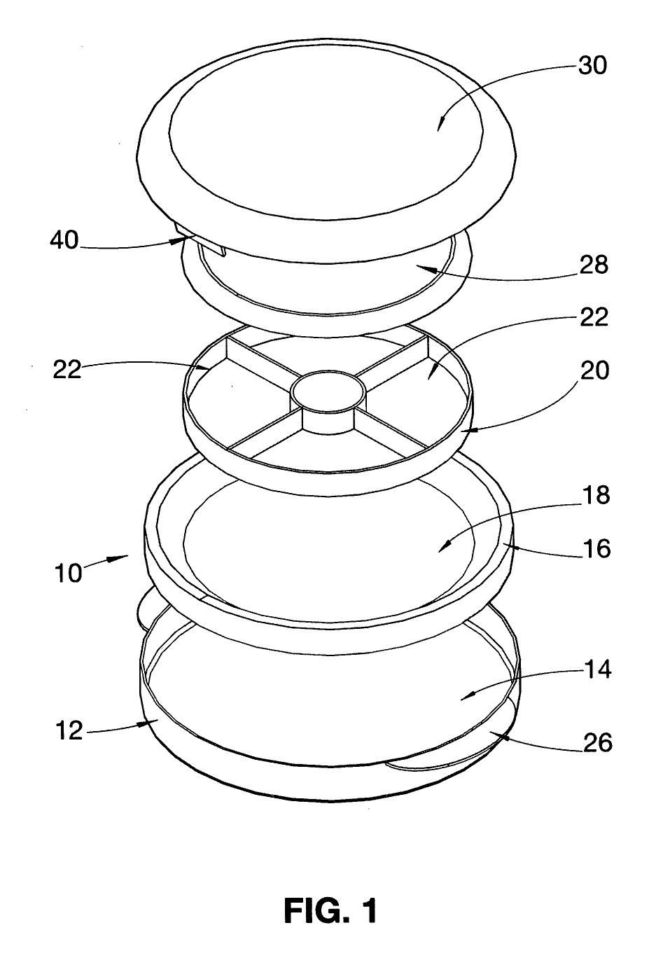

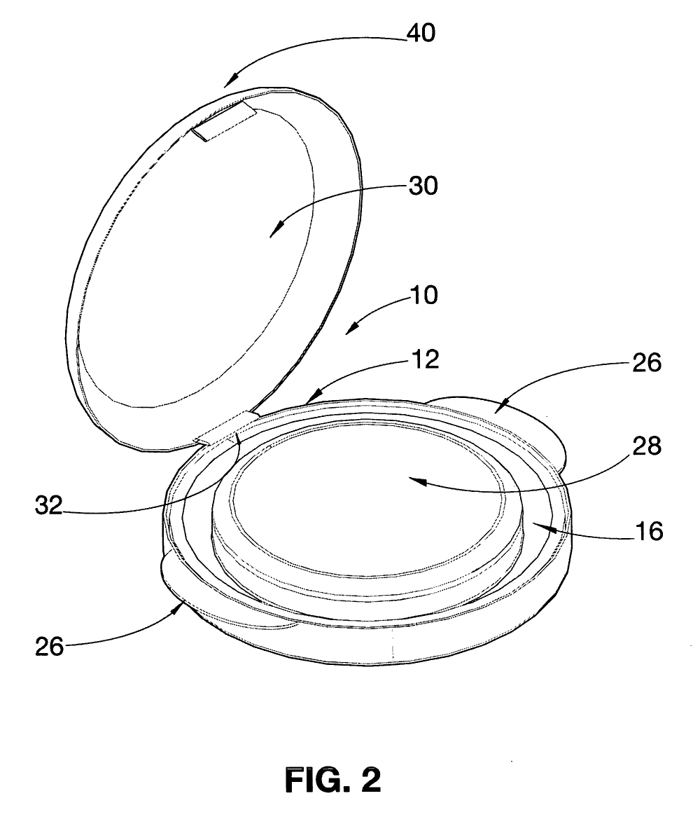

Reference is now made, more particularly, to the drawing FIGS. 1 and 2. Illustrated therein is an apparatus, generally designated 10, for at least one of retaining pre-selected food products (not shown) and serving such pre-selected food products as desired.

The apparatus 10 includes a bottom member 12 having each of a first predetermined shape, a first predetermined size and a first predetermined thickness. The bottom member 12 will be formed from a first predetermined material having a predetermined hardness which is at least sufficient to provided a stiffness to said bottom member to prevent bending thereof. Such first predetermined material is preferably selected from the group consisting of metal and plastic with plastic being the most preferred from a cost standpoint.

There is a first cavity 14 formed in such bottom member 12. The first cavity 14 includes each of a second predetermined shape, a second predetermined size and a first predetermined depth. In the presently preferred embodiment of the invention, the first predetermined shape of the bottom member and the second predetermined shape of the first cavity are substantially identical and such first predetermined shape of the bottom member 12 and such second predetermined shape of the first cavity 14 are substantially identical.

A cooling gel member 16 including a third predetermined shape, a third predetermined size and a second predetermined thickness is disposed within such first cavity 14. There is a second cavity 18 formed in the cooling gel member 16 having each of a fourth predetermined shape, a fourth predetermined size and a second predetermined depth. In the presently preferred embodiment, the first predetermined depth of the first cavity 14 is greater than the second predetermined depth of such second cavity 18.

The final essential element of the apparatus 10 is a plate member 20 which is disposed within said second cavity. Plate member 20 includes each of a fifth predetermined shape and a fifth predetermined size. 8. In the presently preferred embodiment, the plate member 20 includes a predetermined plurality of compartments 22 for maintaining different food products separated. Each of the plurality of compartments 22 have a fifth predetermined shape which is preferably pie shaped. Additionally, in the presently preferred embodiment the plate member 20 further includes a generally round compartment 24 formed substantially in a center thereof for holding a vegetable dip.

It is presently preferred that the bottom member 12 further includes a pair of handle members 26 disposed on an outer edge thereof. Preferably, such handle members 26 are formed integrally with the bottom member 12 as a single piece bottom member.

It is also presently preferred that the apparatus 10 will further include at least one lid member. in the most preferred embodiment the apparatus 10 will include both the lid 28 and an outer lid 30. Outer lid 30 preferably includes a means, generally designated 40, disposed along an outer edge thereof for locking such outer lid 30 to the bottom member 12 when such apparatus 10 is not in use. It is likewise preferred that at least one of such inner lid 28 and such outer lid 30 is transparent and that such outer lid member 30 is hinged to the bottom member 12 by a hinge member 32.

It is further presently preferred that each of such bottom member 12, the cooling gel member 16, the plate member 20, the inner lid member 28 and the outer lid member 30 are formed as separate members to facilitate cleaning thereof after use.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus for at least one of retaining pre-selected food products and serving such pre-selected food products as desired, said apparatus comprising:
(a) a bottom member having each of a first predetermined shape, a first predetermined size and a first predetermined thickness, said bottom member formed from a first predetermined material having a predetermined hardness which is at least sufficient to provided a stiffness to said bottom member to prevent bending thereof;
(b) a first cavity formed in said bottom member having each of a second predetermined shape, a second predetermined size and a first predetermined depth;
(c) a cooling gel member having each of a third predetermined shape, a third predetermined size and a second predetermined thickness disposed within said first cavity;
(d) a second cavity formed in said cooling gel member having each of a fourth predetermined shape, a fourth predetermined size and a second predetermined depth; and
(e) a plate member having each of a fifth predetermined shape and a fifth predetermined size disposed within said second cavity.

2. An apparatus, according to claim 1, wherein said first predetermined shape and said second predetermined shape are substantially identical.

3. An apparatus, according to claim 2, wherein said first predetermined size of said bottom member is greater than said second predetermined size of said first cavity.

4. An apparatus, according to claim 3, wherein said first predetermined material is selected from the group consisting of metal and plastic.

5. An apparatus, according to claim 4, wherein said first predetermined depth of said first cavity is greater than said second predetermined depth of said second cavity.

6. An apparatus, according to claim 1, wherein said bottom member further includes a pair of handle members disposed on an outer edge thereof.

7. An apparatus, according to claim 6 wherein said handle members are formed integrally with said bottom member as a single piece bottom member.

8. An apparatus, according to claim 1, wherein said plate member includes a predetermined plurality of compartments for maintaining different food products separated, each of said plurality of compartments have a fifth predetermined shape.

9. An apparatus, according to claim 8, wherein said fifth predetermined shape of said plurality of compartments is pie shaped.

10. An apparatus, according to claim 9, wherein said plate member further includes a generally round compartment formed substantially in a center thereof for holding a vegetable dip.

11. An apparatus, according to claim 1, wherein said apparatus further includes at least one lid member.

12. An apparatus, according to claim 11, wherein said apparatus includes an inner lid and an outer lid.

13. An apparatus, according to claim 12, wherein said outer lid includes a means disposed along an outer edge thereof for locking said outer lid to said bottom member.

14. An apparatus, according to claim 13, wherein at least one of said inner lid and said outer lid is transparent.

15. An apparatus, according to claim 14, wherein each of said inner lid and said outer lid are transparent.

16. An apparatus, according to claim 1, wherein each of said bottom member, said cooling gel member, said plate member, said inner lid member and said outer lid member are separate members to facilitate cleaning thereof after use.

17. An apparatus, according to claim 12, wherein said outer lid member is hinged to said bottom member.
